(19) United States
(12) Patent Application Publication
(10) Pub. No.: US 2014/0359541 A1
(43) Pub. Date: Dec. 4, 2014

(54) TERMINAL AND METHOD FOR CONTROLLING MULTI-TOUCH OPERATION IN THE SAME

(71) Applicant: Electronics and Telecommunications Research Institute, Daejeon (KR)

(72) Inventor: Juyoung PARK, Daejeon (KR)

(73) Assignee: Electronics and Telecommunications Research Institute, Daejeon (KR)

(21) Appl. No.: 14/096,894

(22) Filed: Dec. 4, 2013

(30) Foreign Application Priority Data
May 29, 2013 (KR) 10-2013-0061244

(51) Int. Cl. G06F 3/0488

(52) U.S. Cl. CPC G06F 3/0488
USPC 715/863

(57) ABSTRACT

A terminal is provided. The terminal includes a first sensor disposed in a screen region and configured to sense a user's first touch, a second sensor disposed in a region other than the screen region and configured to sense at least two user's second touches, and a controller configured to perform a multi-touch operation when the first touch is sensed through the first sensor and at least one of the second touch is sensed through the second sensor.

### CROSS-REFERENCE TO RELATED APPLICATION

This application claims priority to and the benefit of Korean Patent Application No. 10-2013-0061244 filed in the Korean Intellectual Property Office on May 29, 2013, the entire contents of which are incorporated herein by reference.

### BACKGROUND OF THE INVENTION

(a) Field of the Invention

The present invention relates to a terminal using a touch-based input user interface (UI) and a method for controlling a multi-touch operation in the terminal.

(b) Description of the Related Art

With the advent of the BYOD (bring your own device) age, the use of smart terminals has increased all around the world, and even in schools, an educational environment using smart terminals instead of paper books has been promoted.

In terms of development of UIs of existing smart terminals, a one-point touch (single touch) scheme has evolved into a multi-touch scheme. Recently, an increase in a screen size makes it difficult for users to use smart terminals with one hand, as it is for LTE phones, so smart terminals tend to be used with two hands. Meanwhile, in case of smart terminals having a large liquid crystal display size, users choose to use a touch pen.

In using a capacitive multi-touch smart terminal, users may abrade their fingertips. Thus, in order to avoid abrasion, many users use smart terminals by using an auxiliary input tool such as a touch pen.

However, an auxiliary input tool such as a touch pen allows for only one-point touch, having a limitation in its use for the case where a multi-touch is required (e.g., screen zoom-in, zoom-out, or the like).

### SUMMARY OF THE INVENTION

The present invention has been made in an effort to provide a method and apparatus having advantages of substituting for a multi-touch-based input user interface (UI) currently used in terminals (e.g., smart phones).

An exemplary embodiment of the present invention provides a terminal. The terminal includes: a first sensor disposed in a screen region and configured to sense a user's first touch; a second sensor disposed in a region other than the screen region and configured to sense at least two user's second touches; and a controller configured to perform a multi-touch operation when the first touch is sensed through the first sensor and at least one of the second touches is sensed through the second sensor.

The region other than the screen region may be an edge region excluding the screen region in a front surface portion of the terminal.

The region other than the screen region may be a lateral surface region of the terminal.

The terminal may further include a button disposed in the lateral surface of the terminal. When the first touch is sensed through the first sensor after pressing of the button is sensed, the controller may perform the multi-touch operation.

The region other than the screen region may be a rear surface region of the terminal.

The at least two second touches may include a third touch and a fourth touch. When the first touch is sensed through the first sensor after the third touch and the fourth touch are sensed, the controller may perform the same operation as that performed when three touches are sensed in the screen region.

Another embodiment of the present invention provides a method for controlling a multi-touch operation in a terminal. The method for controlling a multi-touch operation includes: sensing at least two user's first touches through a sensor positioned in a region other than a screen region of the terminal; sensing the user's second touch through a sensor position in the screen region; and performing an operation corresponding to a combination of the first touch and the second touch, among operations according to a multi-touch in the screen region.

### BRIEF DESCRIPTION OF THE DRAWINGS

FIG. 1 is a view illustrating a concept of an input user interface (UI) of a multi-touch-based smart terminal according to the related art.

FIG. 2 is a view illustrating a configuration of a smart terminal according to an embodiment of the present invention.

FIG. 3 is a view illustrating an input UI of a smart terminal according to an embodiment of the present invention.

FIG. 4 is a flowchart illustrating a process of controlling a multi-touch operation according to an embodiment of the present invention.

FIG. 5 is a view illustrating an example of comparing the input UI of the smart terminal according to an embodiment of the present invention with the input UI of the smart terminal according to the related art.

FIG. 6 is a view illustrating an example of a single-touch gesture according to an embodiment of the present invention.

FIG. 7 is a view illustrating an example of a multi-touch gesture according to an embodiment of the present invention.

FIG. 8 is a view illustrating another example of a multi-touch gesture according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a smart terminal may refer to a terminal, a mobile terminal (MT), a mobile station (MS), an advanced mobile station (AMS), a high reliability mobile station (HR-MS), a subscriber station (SS), a portable subscriber station (PSS), an access terminal (AT), user equipment (UE), or the like, and may include an entirety or a portion of functions of an MT, an MS, an AMS, an HR-MS, an SS, a PSS, an AT, a UE, or the like.

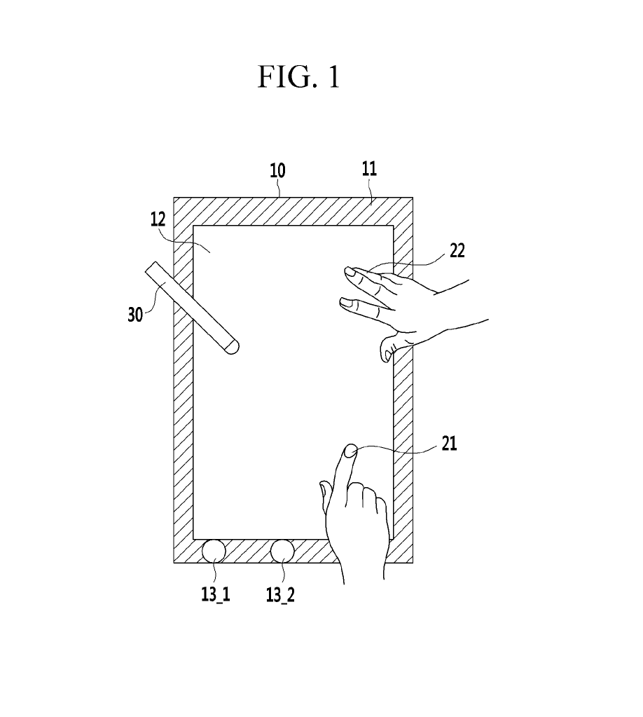

FIG. 1 is a view illustrating a concept of an input user interface (UI) of a multi-touch-based smart terminal according to the related art.

In general, a front surface portion of a smart terminal 10 includes a bezel 11, a screen 12, and at least one function button 13_1 and 13_2. Here, the screen 12 includes a sensor for sensing a user's touch, and the bezel refers to an edge region excluding the screen 12 in the front surface portion of the smart terminal 10.

The touch-based smart terminal input UI is divided into a single touch UI and a multi-touch UI. A single touch refers to pressing or dragging a point on the screen 12 by using a user's finger 21 in order to input handwriting, pointing, or the like. A multi-touch refers to pressing or dragging two or more points on the screen 12 simultaneously by using two or more user fingers 22 in order to magnify a screen (screen zoom-in), reduce a screen (screen zoom-out), move a screen (rotation), or the like.

Meanwhile, recently, in order to avoid abrasion, which is generated as the user repeatedly rubs the screen with fingers, or in order to perform handwriting more minutely, a touch pen 30 or a substitute product may be used.

At least one function button 13_1 and 13_2 may be used to terminate a program, change tasking, use a speed key, and the like.

In such a related art smart terminal input UI scheme, both a single touch and a multi-touch are applied within the region of the screen 12.

Recently, as the smart terminal 10 grows in size, the user increasingly uses the smart terminal 10 held in both hands or may place the smart terminal 10 on a desk to use it. The present invention provides a smart terminal input UI method allowing for utilizing one hand used to hold the smart terminal 10, whereby the user may conveniently use the smart terminal 10.

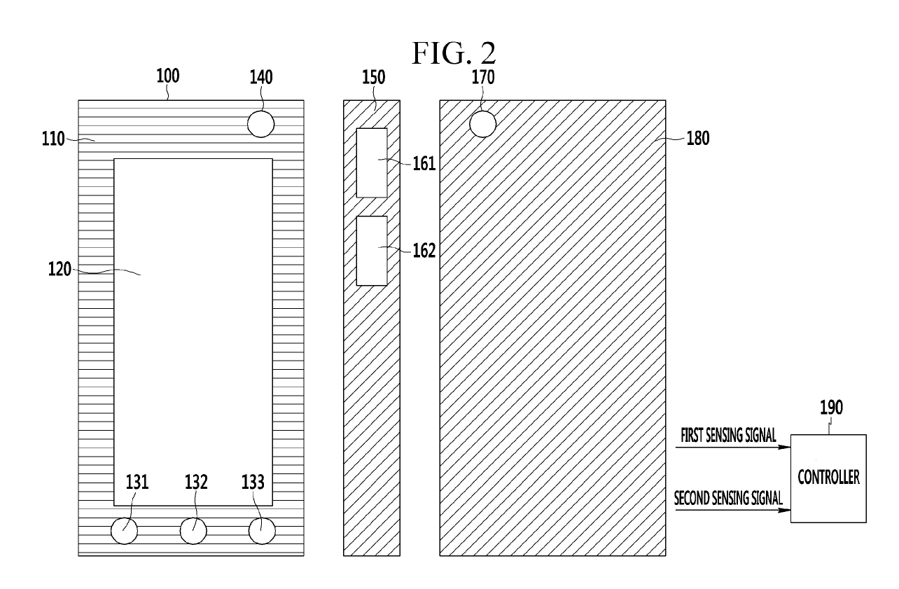

FIG. 2 is a view illustrating a configuration of a smart terminal according to an embodiment of the present invention.

A smart terminal 100 includes a sensor 110 positioned in a bezel region, a sensor 120 positioned in a screen region, function buttons 131 to 133, a front camera 140, a sensor 150 positioned in a lateral surface region, buttons 161 and 162 positioned in the lateral surface region, a rear camera 170, and a controller 190.

The sensors 110 and 120, the buttons 131 to 133, and the front camera 140 are positioned in a front surface portion of the smart terminal 100. The sensor 150 and the buttons 161 and 162 are positioned in the lateral surface portion of the smart terminal 100. The rear camera 170 and a sensor 180 are positioned in the rear surface portion of the smart terminal 100.

The sensors 110, 120, 150, and 180 sense a user's touch.

When a first sensing signal and a second sensing signal are input, the controller 190 performs a multi-touch operation. Here, the first sensing signal is a signal generated when a user's touch is sensed by the sensors 110, 150, and 180 or when pressing of the buttons 161 and 162 is sensed, and the second sensing signal is generated when a use's touch is sensed by the sensor 120. That is, the controller 190 performs a multi-touch operation when a user's touch is sensed by the sensor 120 positioned in the screen region after a user's touch/pressing through the sensors 110, 150, and 180 or the buttons 161 and 162 positioned in regions other than the screen region is sensed. Meanwhile, in FIG. 2, the controller 190 is illustrated outside of the smart terminal 100 for description purpose, but in actuality, the controller 190 is positioned within the smart terminal 100. A specific performing method of a multi-touch operation by the controller 190 is well know to a person skilled in the art (hereinafter referred to as “skilled person”’) to which the present invention pertains, so a detailed description thereof will be omitted.

In order to add a user's input intention, at least any one of the bezel region, the lateral surface region, and the rear surface region, which are regions other than the screen region of the smart terminal 100, may be used.

Meanwhile, the buttons 161 and 162 used generally for the purpose of controlling volume, or the like, may also be used as an input means for a touch-based input UI according to an embodiment of the present invention. That is, a motion of one hand (i.e., the hand holding the smart terminal 100) indicating an input intention may be sensed by using the sensors 110, 150, and 180 or the buttons 161 and 162 positioned in regions other than the screen region.

Meanwhile, in FIG. 2, it is illustrated that the smart terminal 100 includes all the sensors 110, 150, and 180 positioned in the bezel region, the lateral surface region, and the rear surface region, which are those regions other than the screen region thereof. However, this is merely illustrative, and the smart terminal 100 may be designed to include a sensor positioned in at least any one of the bezel region, the lateral surface region, and the rear surface region.

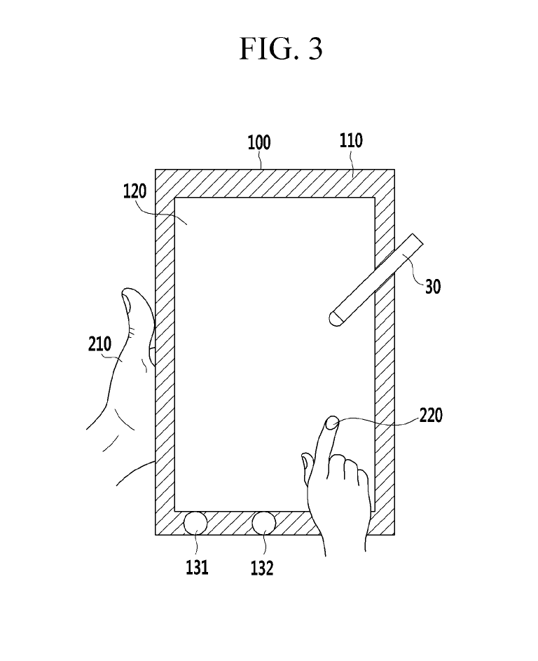

FIG. 3 is a view illustrating an input UI of a smart terminal according to an embodiment of the present invention.

Unless the user uses the smart terminal 100 for inputting while on the move, the user may hold the smart terminal 100 with one hand 210, or when the user is sitting at a desk, the user may stably hold the smart terminal 100 with one hand 210. Here, a multi-touch function may be performed by using the regions (e.g., the bezel region, the lateral surface region, the rear surface region, and the like) other than the screen region of the smart terminal 100.

The user may perform input through an input tool (e.g., a pen 30, a finger 220, or the like). Here, a single touch input through the pen 30, the finger 220, or the like in the screen region may be interpreted as a multi-touch input by using the other hand 210 holding the smart terminal 100. In detail, an intention of a touch applied by the pen 30 or the finger 220 in the screen region may be expressed by touching a particular portion of the bezel region, the lateral surface region, or the rear surface region through the one hand 210 holding the smart terminal 100 or by pressing the buttons 161 and 162 positioned in the lateral surface region.

Meanwhile, the function buttons 131 to 133 positioned in the front surface of the smart terminal 100 may be utilized for the purpose of a manufacturer.

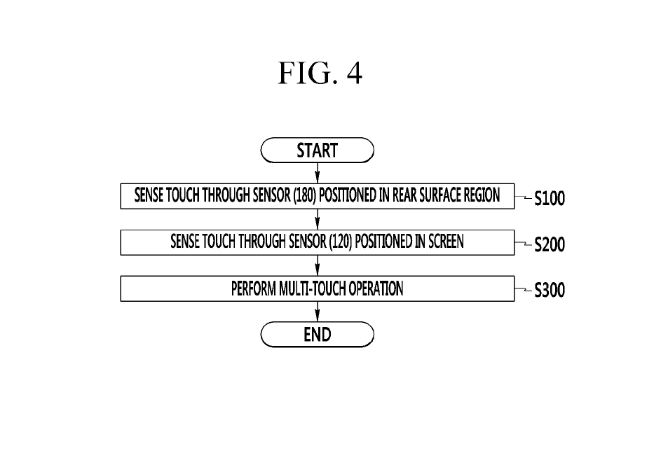

FIG. 4 is a flowchart illustrating a process of controlling a multi-touch operation according to an embodiment of the present invention. In FIG. 4, it is illustrated that the smart terminal 100 includes the sensor 180 positioned in the rear surface region, for description purposes.

First, a user's touch is sensed through the sensor 180 positioned in the rear surface region (S100).

After the user's touch is sensed in step S100, a user's touch is sensed through the sensor 120 positioned in the screen region (S200). Here, the user's touch may be applied through the pen 30.

After the user's touch is sensed by the sensor 180, when a user's touch is sensed by the sensor 120, the controller 190 performs a multi-touch operation (S300). The multi-touch operations mean the operations of the smart terminal 100 performed by input of the user. For example, the multi-touch operations may be screen zoom in and out, move screen (rotation), click, drag, screen change, open, or the like.

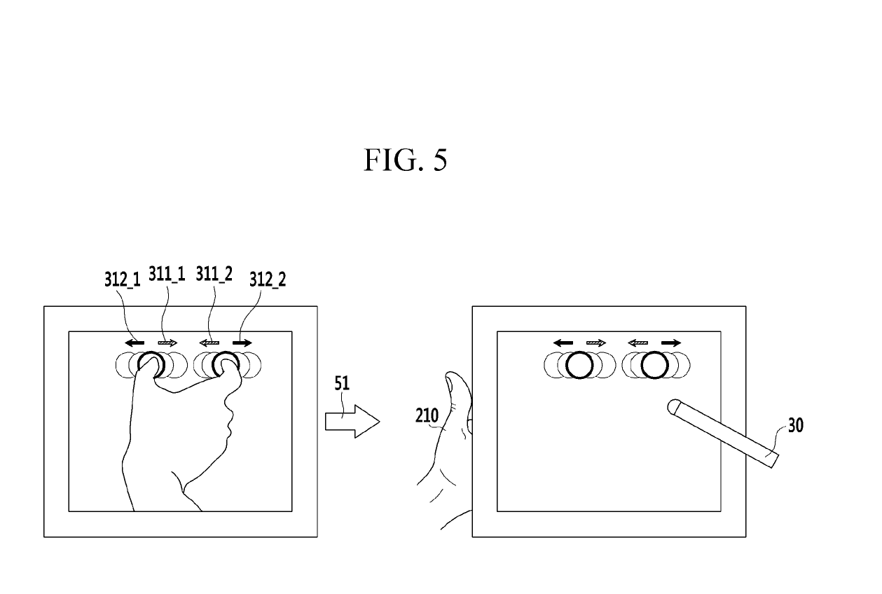

FIG. 5 is a view illustrating an example of comparing the input UI of the smart terminal according to an embodiment of the present invention with the input UI of the smart terminal according to the related art. Hereinafter, a multi-touch for executing a screen zoom-in/zoom-out function will be descried as an example. The left side of an arrow 51 shows the related art multi-touch input scheme, and the right side of the arrow 51 shows a multi-touch input scheme according to an embodiment of the present invention.

In the related art, in order to perform a screen zoom-in/zoom-out function, two spots in the screen region are pressed by using two fingers, and a space between the two fingers is reduced (311_1, 311_2) or the space between the two fingers is increased (312_1, 312_2).

In an embodiment of the present invention, first, the user touches/presses the sensors 110, 150, and 180 or the buttons 161 and 162 present in regions (e.g., the bezel region, the lateral surface region, and the rear surface region) other than the screen region, by using one hand 210 holding the smart terminal 100, to indicate the multi-touch. Accordingly, by using the pen 30 or one finger that may be able to point to only one spot in the screen region, the same function as that (e.g., screen zoom-in/zoom out function) of the related art according to the multi-touch in the screen region may be performed.

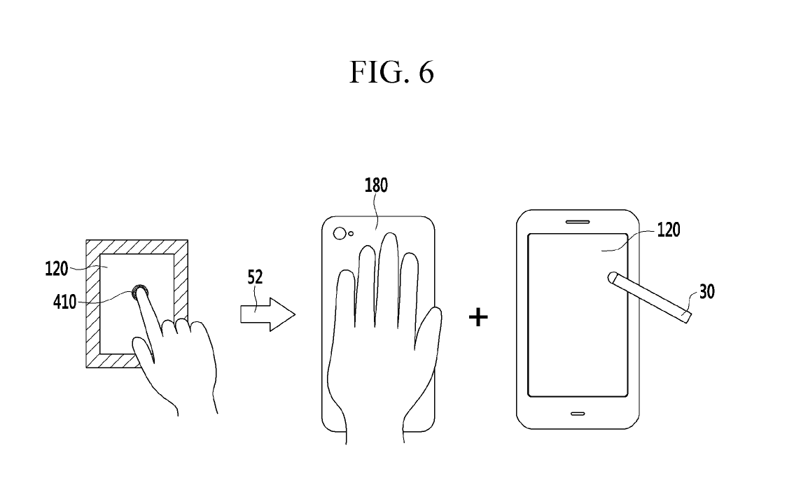

FIGS. 6 through 8 illustrate a single-touch or a multi-touch gesture proposed in an embodiment of the present invention. Hereinafter, for description purposes, a case in which the user holds the smart terminal 100 with the left hand, the user touches the screen region through the pen 30 held by the right hand, and the smart terminal 100 includes the sensor 180 positioned in the rear surface region, will be described.

FIG. 6 is a view illustrating an example of a single-touch gesture according to an embodiment of the present invention.

The left side of an arrow 52 shows the related art smart terminal input scheme, which shows a single touch gesture using one finger. A function based on a single touch applied to one spot 410 in the screen region may differ according to a device. In general, functions such as a screen point, drag, letter input, or the like, are executed through a single touch.

The right side of the arrow 52 shows a single touch gesture proposed in an embodiment of the present invention. A smart terminal input UI according to an embodiment of the present invention determines a user's input intention by using the sensor 180 existing in a region (e.g., the rear surface region) other than the screen region, and here, in case of a single touch, a corresponding function (e.g., letter input or the like) may be executed by touching the screen region by using only the pen 30 in the same manner as that of the related art.

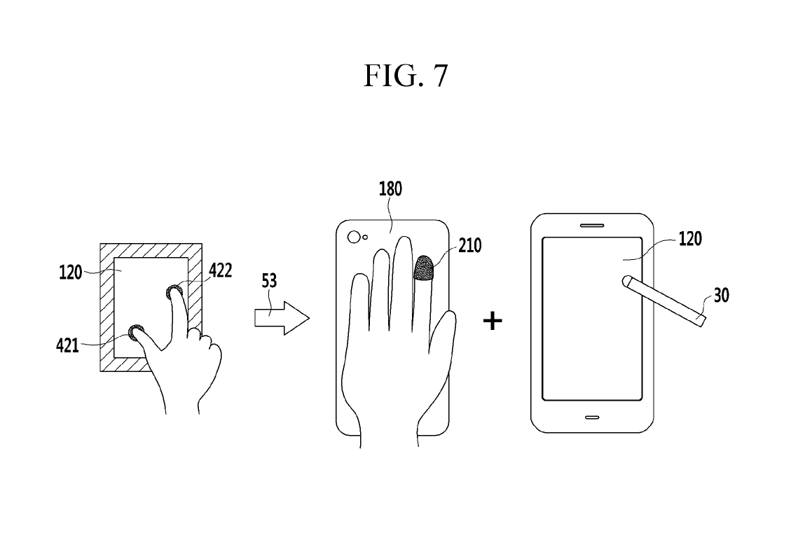

FIG. 7 is a view illustrating an example of a multi-touch gesture according to an embodiment of the present invention.

The left side of an arrow 53 shows the related art smart terminal input scheme, which shows a multi-touch gesture using two fingers. A function based on the multi-touch applied to two spots 421 and 422 may differ according to a device, and in general, functions such as screen zoom-in/zoom-out, rotation, and the like, are executed through a multi-touch.

The right side of the arrow 53 shows a multi-touch gesture proposed in an embodiment of the present invention,

After a spot of a region (e.g., the rear surface region) other than the screen region is touched with one finger 210, the screen region is touched through the pen 30. Although a single touch is applied through the pen 30, the same function as the related art function (e.g., screen zoom-in, screen zoom-out, rotation, or the like) according to a multi-touch using two fingers in the screen region can be executed through the single touch.

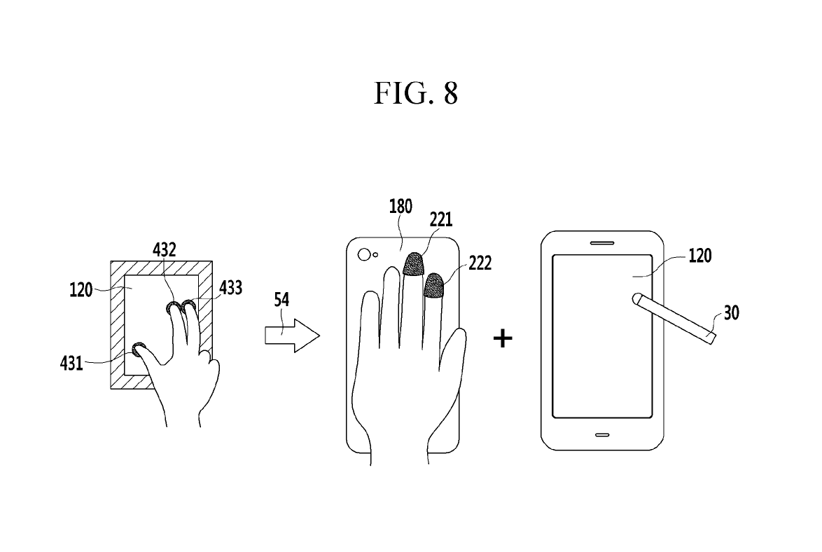

FIG. 8 is a view illustrating another example of a multi-touch gesture according to an embodiment of the present invention.

The left side of the arrow 54 shows the related art smart terminal input scheme, which shows a multi-touch gesture using three fingers. The function based on the multi-touch applied to three spots 431, 432, and 433 in the screen region may differ according to a device, and mainly, a function specified for an application program, or the like, is executed through the multi-touch.

The right side of the arrow 54 shows a multi-touch gesture proposed in an embodiment of the present invention. After two spots of a region (e.g., the rear surface region) other than the screen region are touched with two fingers 221 and 222, the screen region is touched through the pen 30. Although the single touch is applied through the pen 30, the same function as the related art function according to the multi-touch using three fingers in the screen region can be executed through the single touch.

The present invention provides a future-oriented smart terminal user interface (UI) scheme in which a multi-touch scheme can be used by using a region other than the screen region of the terminal.

The smart terminal UI scheme according to an embodiment of the present invention may replace the currently commonly used multi-touch UI scheme in the screen region.

According to embodiments of the present invention, when the smart terminal is used with both hands or when a touch pen as an auxiliary input means is used due to the large screen of the smart terminal, movements requiring two or more fingers can be sufficiently performed with only one finger (or a touch pen). Thus, limitations in manipulating the smart terminal requiring various multi-touch gestures can be overcome.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A terminal comprising:
a first sensor disposed in a screen region and configured to sense a user's first touch;
a second sensor disposed in a region other than the screen region and configured to sense at least two user's second touches; and
a controller configured to perform a multi-touch operation when the first touch is sensed through the first sensor and at least one of the second touches is sensed through the second sensor.

2. The terminal of claim 1, wherein the region other than the screen region is an edge region excluding the screen region in a front surface portion of the terminal.

3. The terminal of claim 1, wherein the region other than the screen region is a lateral surface region of the terminal.

4. The terminal of claim 1, further comprising
a button disposed in the lateral surface of the terminal,
wherein when the first touch is sensed through the first sensor after pressing of the button is sensed, the controller performs the multi-touch operation.

5. The terminal of claim 1, wherein the region other than the screen region is a rear surface region of the terminal.

6. The terminal of claim 1, wherein the first touch is applied through a pen.

7. The terminal of claim 1, wherein the at least two second touches include a third touch and a fourth touch,
wherein when the first touch is sensed through the first sensor after the third touch and the fourth touch are sensed, the controller performs the same operation as that performed when three touches are sensed in the screen region.

8. A method for controlling a multi-touch operation in a terminal, the method comprising:
sensing at least two user's first touches through a sensor positioned in a region other than a screen region of the terminal;
sensing the user's second touch through a sensor positioned in the screen region; and
performing an operation corresponding to a combination of the first touch and the second touch, among operations according to a multi-touch in the screen region.

9. The method of claim 8, wherein the region other than the screen region is an edge region excluding the screen region in a front surface portion of the terminal.

10. The method of claim 8, wherein the region other than the screen region is a rear surface region of the terminal.

11. The method of claim 8, wherein the at least two first touches include a third touch and a fourth touch,
wherein when the second touch is sensed after the third and fourth touches are sensed, the same operation as that performed when three touches are sensed in the screen region is performed.

12. The method of claim 11, wherein the second touch is applied through a pen.
